(19) United States
(12) Patent Application Publication
(10) Pub. No.: US 2015/0372854 A1
(43) Pub. Date: Dec. 24, 2015

(54) COMMUNICATION CONTROL DEVICE, COMMUNICATION CONTROL PROGRAM, AND COMMUNICATION CONTROL METHOD

(71) Applicant: FUJITSU LIMITED, Kawasaki-shi (JP)

(72) Inventor: Yushiro Furukawa, Yokohama (JP)

(21) Appl. No.: 14/710,639

(22) Filed: May 13, 2015

(30) Foreign Application Priority Data
Jun. 24, 2014 (JP) 2014-128867

(51) Int. Cl. H04L 12/24; G06F 9/455

(52) U.S. Cl. CPC H04L 41/02; G06F 9/45558; G06F 2009/45595

(57) ABSTRACT

A communication control device includes a storage that stores management information in which an first address of a network interface of a first information processing device for which first communication with the communication control device has been allowed, first identification information corresponding to the first address, and first port information corresponding to a first port of the communication control device for which the first communication has been allowed are associated with one another, and a determination processor that determines whether or not to allow second communication with a second information processing device on a basis of the first identification information and a second identification information, which has been received from the second information processing device performing the second communication.

### CROSS-REFERENCE TO RELATED APPLICATION

This application is based upon and claims the benefit of priority of the prior Japanese Patent Application No. 2014-128867, filed on Jun. 24, 2014, the entire contents of which are incorporated herein by reference.

### FIELD

The present invention relates to a communication control device, a communication control program, and a communication control method.

### BACKGROUND

Following the performance improvement of physical devices (also referred to hereinbelow as “physical machines” and “VM hosts”), the research of virtualization technique by which a plurality of virtual devices (also referred to hereinbelow as “virtual machines” and “VM”) are aggregated in one physical machine has been advanced. For example, with the virtualization technique, virtualization software (hypervisor) allocates a physical machine to a plurality of virtual machines and can provide services by an application program (also referred to hereinbelow as “application”) installed in each virtual machine. In recent years, data center operators (also referred to hereinbelow as “operators”) have been lending virtual machines to users. An operator lends a virtual machine to a user on the basis of conditions defined by a contract.

A management server that manages information relating to a network interface such as a media access Control address (MAC address) of a virtual machine is sometimes provided to enable the operator to control the virtual machine. The management server, for example, allocates a new MAC address when a virtual machine is created. As a result, for example, a communication control device (also referred to hereinbelow as “switch”) provided in the network including the virtual machine can determine whether or not to relay a packet received from each virtual machine, on the basis of the MAC address allocated to each virtual machine (see, for example, Japanese Patent Application Publication No. 2010-171505, Japanese Patent Application Publication No. 2004-343497).

### SUMMARY

Where an operator lends a virtual machine to a user, the lent virtual machine is sometimes managed by the user. In this case, the user can rewrite the MAC address allocated by the management server to the virtual machine by the functions of an operation system (also referred to hereinbelow as “OS”) that has been installed by the user himself. Therefore, where a malicious user is present, this user, for example, can rewrite the MAC address of the virtual machine, which is managed by the user himself, to duplicate the MAC address allocated to the virtual machine that has been lent to another user. In this case, the malicious user can intercept communication relating to another virtual machine.

According to an aspect of the embodiments, a communication control device includes: a storage that stores management information in which an first address of a network interface of a first information processing device for which first communication with the communication control device has been allowed, first identification information corresponding to the first address, and first port information corresponding to a first port of the communication control device for which the first communication has been allowed are associated with one another; and a determination processor that determines whether or not to allow second communication with a second information processing device on a basis of the first identification information and a second identification information, which has been received from the second information processing device performing the second communication, when the second communication is to be performed with the second information processing device transmitting a packet including the first address, in a case where the first address and a second port information corresponding to a second port of the communication control device that is to receive the packet have not been stored in association with each other in the storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts the entire configuration of an information processing system.

FIGS. 2 and 3 illustrate an Ethernet fabric switch.

FIGS. 4 to 6 illustrate the operation at the time the migration of a virtual machine is generated.

FIG. 7 illustrates the operations relating to the case of fraudulent communication performed by a malicious user.

FIG. 8 illustrates the hardware configuration of the communication control device.

FIG. 9 is a block diagram relating to the functions of the communication control device depicted in FIG. 8.

FIG. 10 is a flowchart summarizing the communication control processing of the first embodiment.

FIGS. 11 and 12 are flowcharts illustrating the details of the communication control processing in the first embodiment.

FIGS. 13 to 21 illustrate the details of the communication control processing in the first embodiment.

FIGS. 22 to 24 illustrate the communication control processing in the second embodiment.

### DESCRIPTION OF EMBODIMENTS

(Configuration of Information Processing System)

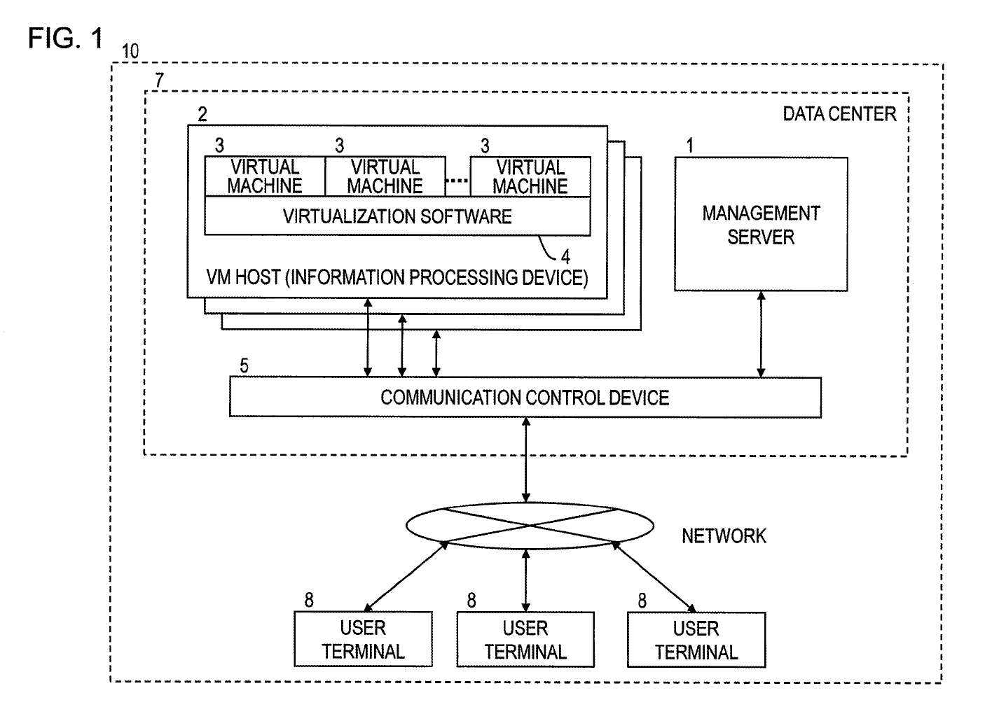

FIG. 1 depicts the entire configuration of an information processing system. An information processing system 10 depicted in FIG. 1 is provided with a management server 1 (also referred to hereinbelow as “management device 1”) and an information processing device 2 (also referred to hereinbelow as “VM host 2” or “physical machine 2”) inside a data center 7. A user terminal 8 can be connected to the data center 7 via a network such as Internet or intranet. Further, communication between the VM host 2 and the user terminal 8 is performed, for example, via a communication control device 5 (also referred to hereinbelow as “switch 5”) provided inside the data center 7. In the example depicted in FIG. 1, the user terminal 8 is connected to the information processing device 2 via the communication control device 5, but the connection to the information processing device 2 may be also realized via another switch or the like. Explained hereinbelow is the case in which the information processing device 2 is a VM host 2 that can create a virtual machine (also referred to hereinbelow as “VM”).

In the example depicted in FIG. 1, the VM host 2 is constituted by a plurality of physical machines, and each physical machine has a CPU, a memory (DRAM), a high-capacity memory such as a hard disk (HDD), and a network. Resources of the VM host 2 are allocated to a plurality of virtual machines 3.

The management server 1 can communicate with the virtual machines 3 and manages the virtual machines 3 created inside the VM host 2. For example, the management server 1 may be created by the virtual machines 3. For example, the management server 1 allocates a MAC address (also referred to hereinbelow as “address of network interface”) to the virtual machines 3 created in the VM host 2.

For example, the virtual machine 3 provides the infrastructure thereof to the user via a network (also referred to hereinbelow as “cloud service”). The cloud service is a service of providing, via the network, a platform for constructing and operating a computer system, that is, the infrastructure itself of the virtual machine 3 and the network. For example, the user accesses a cloud service portal site from the user terminal 8, selects specifications necessary for the virtual machine, for example, the clock frequency of the CPU, the capacity (GB) of the memory, the capacity (MB/sec, IOPS) of the hard disk, and the communication bandwidth (Gbps) of the network, and signs a cloud user contract with respect to those specifications. The user terminal 8 can also, for example, monitor the operation state of the virtual machines 3 and perform operations relating to the virtual machines.

A virtualization software 4 is platform software that operates the virtual machines 3 by allocating the CPU, memory, hard disk, and network of the VM host 2 in response to an instruction from the management server 1. The virtualization software 4 is operated, for example, by the VM host 2.

In addition to the allocated resources of the VM host 2, the virtual machine 3 has on the hard disk thereof an image file having an OS, middleware, an application, and a database. For example, when started, the virtual machine 3 writes the image file from the hard disk into the memory and performs operations corresponding to the desired service.

The communication control device 5 is, for example, a L2 switch and operates using a MAC address which is an identifier of a data link layer (second layer) of an OSI reference model. More specifically, for example, the communication control device 5 stores information relating to the MAC address, for which communication is allowed, for each port in the communication control device 5 and transmits, by relaying, only a packet including the stored MAC address (for which communication is allowed) to a destination.

The communication control device 5 may be also, for example, the switch 5 (also referred to hereinbelow “Ethernet fabric switch 5”) using an Ethernet fabric technology. In the next paragraph, the explanation of the Ethernet fabric switch is provided.

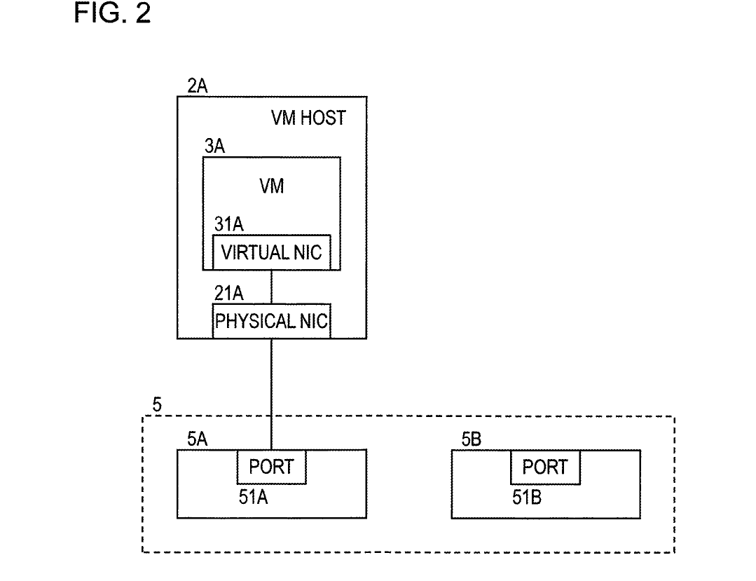

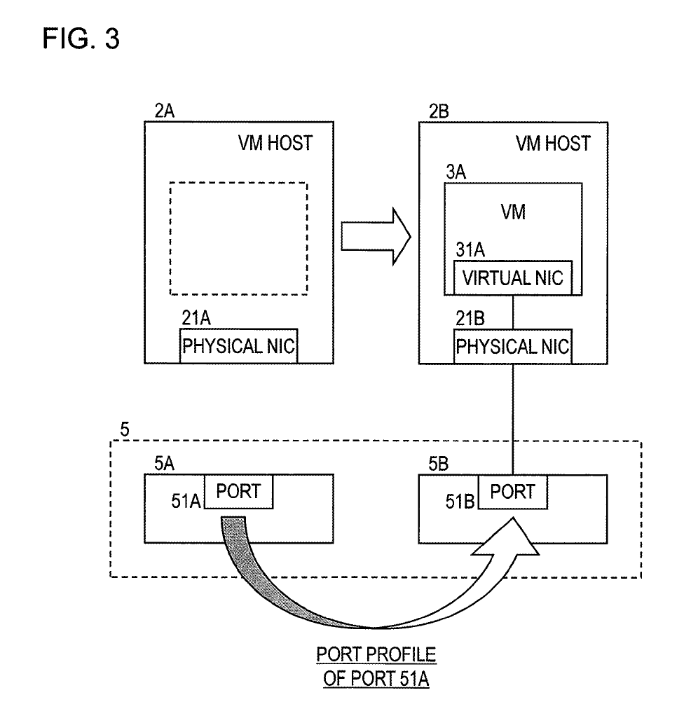

FIGS. 2 and 3 illustrate an Ethernet fabric switch. In the Ethernet fabric technology, a plurality of physical switches (switches 5A, 5B in FIG. 2) are operated as one logical switch (switch 5 in FIG. 2). More specifically, the Ethernet fabric switch, for example, can automatically set a routing between physical switches constituting the Ethernet fabric switch. Therefore, for example, even when some of the physical switches constituting the Ethernet fabric switch fail, the routing which does not include the failed physical switches can be automatically set. By using the Ethernet fabric switch, an operator, for example, can reduce the time and cost of managing the physical switches in the network.

Further, in the Ethernet fabric switch, an allowed communication band, security, and a virtual LAN (VLAN) can be set for each port of each physical switch (information relating to such settings can be also referred to hereinbelow as “port profile”). For example, where the Ethernet fabric switch detects migration of a virtual machine, a port profile that has been set in the port of the migration source can be automatically used in the port of the migration destination. More specifically, as depicted in FIG. 3, when the virtual machine 3A migrates from a VM host 2A to a VM host 2B, the port profile of a port 51A can be automatically used in the newly connected port 51B.

(Operation of Communication Control Device During Migration Execution)

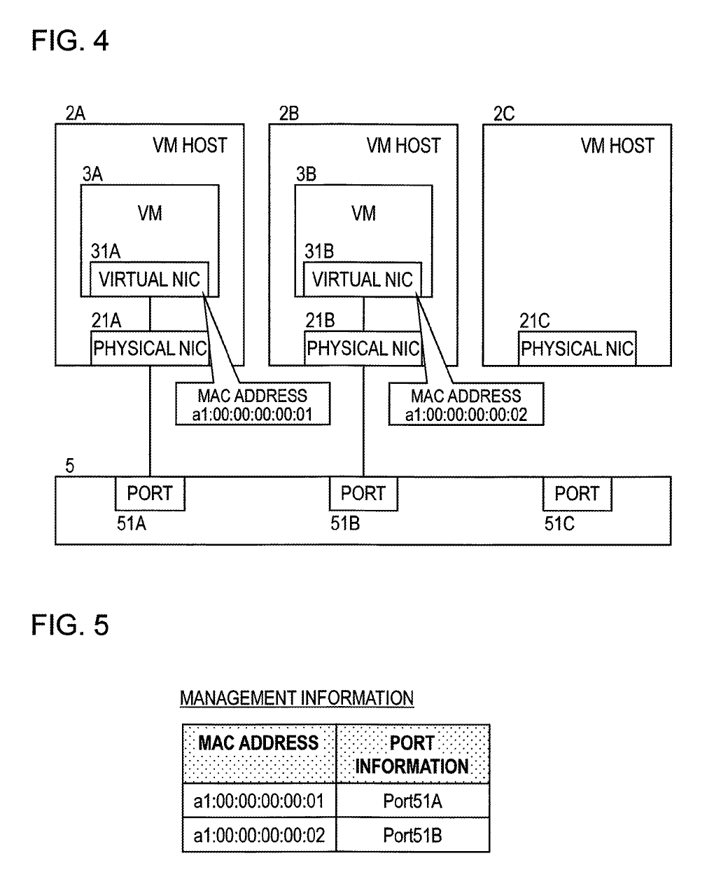

The operation of the communication control device 5 during migration execution of a virtual machine is explained hereinbelow. FIGS. 4 to 6 illustrate the operation at the time the migration of a virtual machine is generated.

The communication control device 5 depicted in FIG. 4 is, for example, the Ethernet fabric switch explained with reference to FIGS. 2 and 3 and has ports 51A, 51B, and 51C. In the example depicted in FIG. 4, the virtual machine 3A created in the VM host 2A is allowed to communicate with the communication control device 5 in the port 51A, and the virtual machine 3B created in the VM host 2B is allowed to communicate with the communication control device 5 in the port 51B. The explanation hereinbelow assumes that the MAC address of a virtual NIC 31A of the virtual machine 3A is a1:00:00:00:00:01, and the MAC address of a virtual NIC 31A of the virtual machine 3B is a1:00:00:00:00:02, as illustrated by FIG. 4. Further, in the example depicted in FIG. 4, the virtual machine 3A communicates with the communication control device 5 via the virtual NIC 31A and a physical NIC 21A, and the virtual machine 3B communicates with the communication control device 5 via a virtual NIC 31B and a physical NIC 21B.

FIG. 5 illustrates an example of management information for managing the communication allowed by the communication control device 5 in the case illustrated by FIG. 4. The management information in FIG. 5 has as items a “MAC address” which is the MAC address of the virtual machine for which communication is allowed and “port information” which is information corresponding to the port for which communication is allowed. In the management information depicted in FIG. 5, a1:00:00:00:00:01, which is the MAC address of the virtual NIC 31A, is associated with Port51A which is “port information” on the port 51A. Further, a1:00:00:00:00:02, which is the MAC address of the virtual NIC 31B, is associated with Port51B which is “port information” on the port 51B. Thus, the management information in the example depicted in FIG. 5 indicates that the communication of the port 51A has been confirmed and the communication of the port 51B has been confirmed.

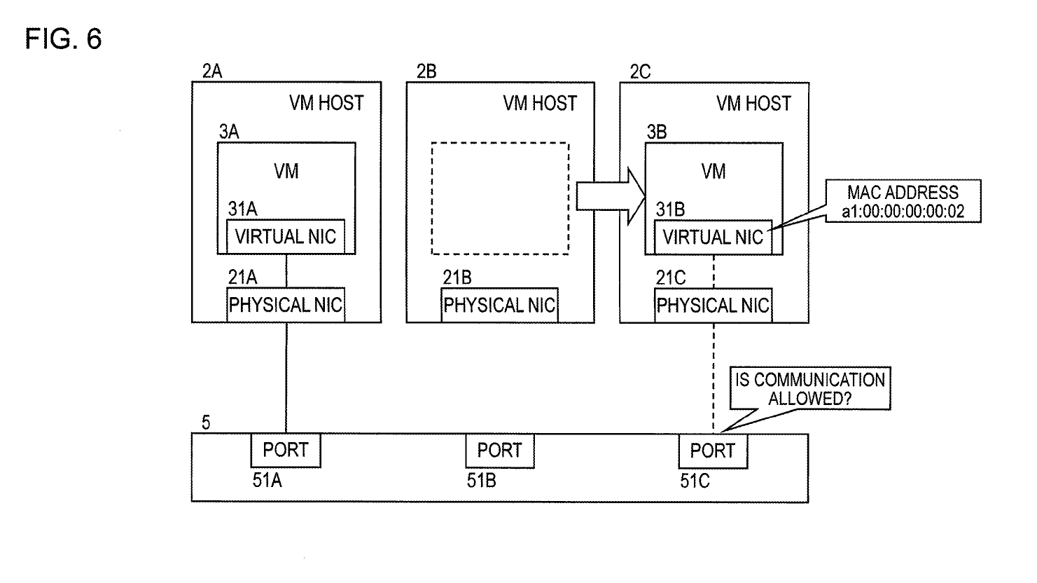

FIG. 6 illustrates the case in which the virtual machine 3B has migrated from the VM host 2B (state depicted in FIG. 4) to the VM host 2C. Thus, FIG. 6 illustrates an example in which the migrated virtual machine 3B has transmitted the initial packet to the port 51C. In this case, the communication control device 5 checks, by referring to the management information depicted in FIG. 5, whether or not the MAC address (a1:00:00:00:00:02 in the example depicted in FIG. 6) included in the received packet has been stored. Further, in the example depicted in FIG. 6, the MAC address included in the received packet has been stored in the management information. Therefore, the communication control device 5 approves of the communication from the virtual machine 3B to the port 51C. Thus, when the MAC address included in the received packet has been stored in the management information, the communication control device 5 allows the commutation of the received packet even when the MAC address included in the received packet and the port that has received the packet are not stored correspondingly to each other in the management information.

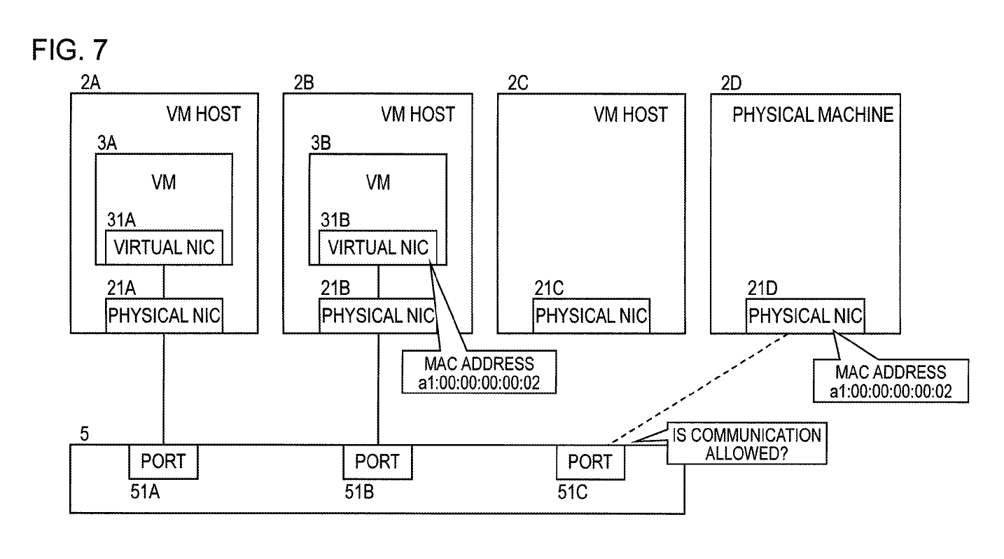

An example of communication performed by a malicious user is explained hereinbelow. FIG. 7 illustrates the operations relating to the case of fraudulent communication performed by a malicious user. In the example depicted in FIG. 7, it is assumed that the MAC address of a physical machine 2D is rewritten by the user of the physical machine 2D as a1:00:00:00:00:02 which is the MAC address of the virtual machine 3B.

In this case, when a packet is received from the physical machine 2D, since the MAC address included in the received packet is present in the management information, the communication control device 5 allows the communication with the physical machine 2D in the port 51C. Thus, where a packet including the MAC address of the virtual machine 3B is received, the communication control device 5 cannot distinguish between the case in which the received packet has been transmitted to the port 51C under the effect of virtual machine migration and the case in which a malicious user has transmitted the packet to the port 51C. Therefore, in some cases, the malicious user can intercept the communication of the virtual machine 3B by rewriting the MAC address of the physical machine 2D as the MAC address same as that of the virtual machine 3B.

Meanwhile, in some cases, a VLAN relating to a machine receiving a packet should be set in advance in the communication control device 5 for the communication control device 5 to allow the communication of the received packet. In such a case, even when a malicious user rewrites the MAC address as indicated hereinabove, the setting of VLAN relating to the machine managed by the user himself cannot be performed in the communication control device 5. Therefore, in this case, the malicious user cannot intercept the communication performed by another user. However, for example, where the communication control device 5 is the abovementioned Ethernet fabric switch, the communication control device 5 sometimes automatically sets the VLAN to optimize the network. As a result, depending on the set contents of the VLAN, a malicious user can sometimes intercept the communication performed by another user.

Accordingly, in the present embodiment, when communication is performed with the virtual machine 3 that transmits a packet including a MAC address that has been stored in the communication control device 5, it is checked whether or not the MAC address included in the packet which is to be transmitted has been stored in the communication control device 5 in association with the port that is to receive the packet. Where the address has not thus been stored in the communication control device 5, the communication control device 5 performs the determination based on an identification information received from the virtual machine 3 performing the communication and the identification information stored in the communication control device 5, and prevents fraudulent communication.

(Configuration of Communication Control Device)

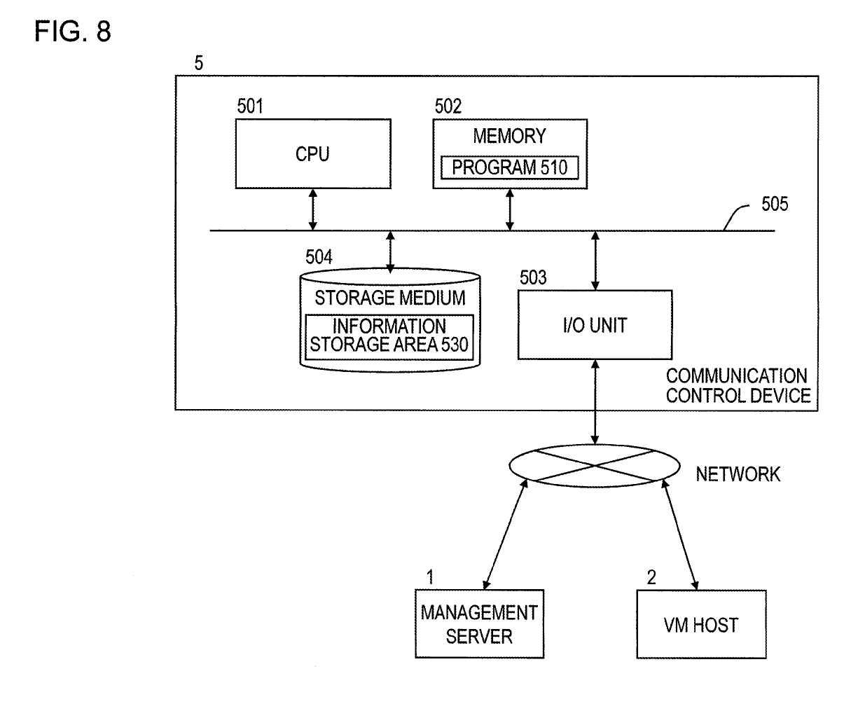

The configuration of the communication control device 5 is initially explained. FIG. 8 illustrates the hardware configuration of the communication control device. The communication control device 5 has a CPU 501, which is a processor, a memory 502, an external interface (I/O unit) 503, and a storage medium 504. The units are connected to each other by a bus 505. The storage medium 504 stores, for example, a program 510 (also referred to hereinbelow as “communication control program”) for performing the processing (also referred to hereinbelow as “communication control processing”) of controlling the communication via the communication control device 5, in a program storage area (not presented in the figure) in the storage medium 504. As depicted in FIG. 8, the CPU 501 loads the program 510 from the storage medium 504 to the memory 502 when the program 510 is to be executed and performs the communication control processing in cooperation with the program 510. The storage medium 504 also has, for example, an information storage area 530 (also referred to hereinbelow as “storage530”) for storing information to be used when performing the communication control processing.

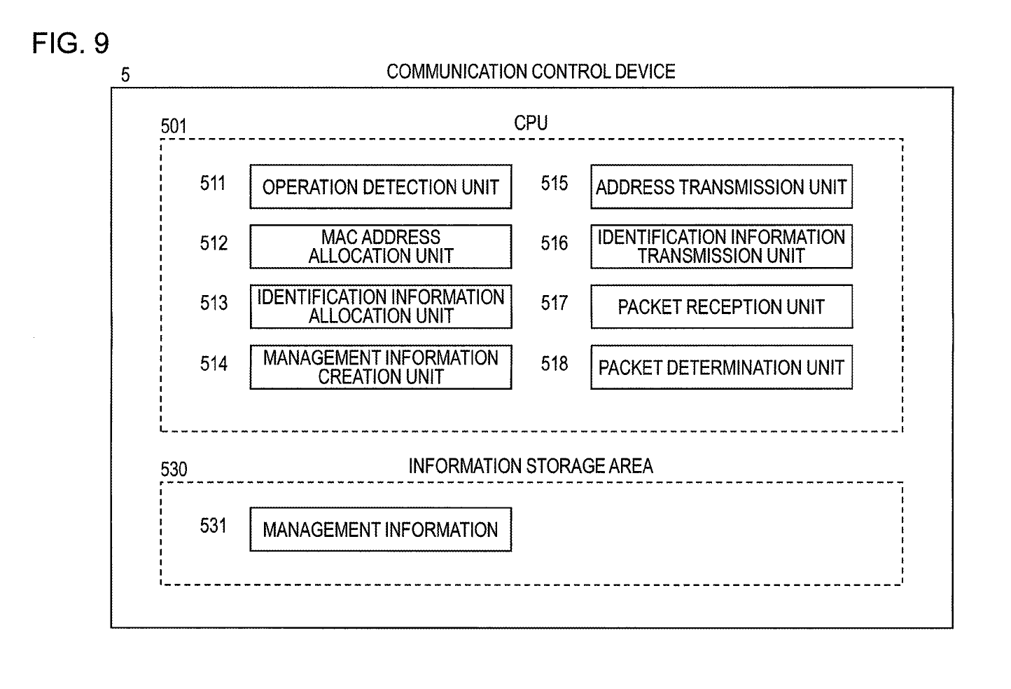

FIG. 9 is a block diagram relating to the functions of the communication control device depicted in FIG. 8. As a result of cooperating with the program 510, the CPU 501 operates, for example, as an operation detection unit 511, a MAC address allocation unit 512, and an identification information allocation unit 513 (either one or both the MAC address allocation unit 512 and the identification information allocation unit 513 can be also referred to hereinbelow as “allocation unit”). Further, as a result of cooperating with the program 510, the CPU 501 operates, for example, as a management information creation unit 514 (also referred to hereinbelow as “update unit 514”), an address transmission unit 515, an identification information transmission unit 516, a packet reception unit 517, and a packet determination unit 518 (also referred to hereinbelow as “determination unit 518”). For example, the management information 531 is stored in the information storage area 530.

For example, the operation detection unit 511 detects a predetermined operation performed by the management server 1. The predetermined operation, as referred to herein, is for example, the creation of the virtual machine 3 to which the resources of the VM host 2 have been allocated.

The MAC address allocation unit 512, for example, allocates a MAC address (also referred to hereinbelow simply as “address”) to the virtual machine 3, which is to communicate with the communication control device 5, before the management information 531 is stored by the management information creation unit 514. Further, the identification information allocation unit 513, for example, allocates identification information (also referred to hereinbelow as “first identification information”) on the MAC address to the virtual machine 3, which is to communicate with the communication control device 5, before the management information 531 is stored by the management information creation unit 514. The identification information is information that can uniquely specify each MAC address. More specifically, the identification information may be, for example, account information such as a user name or password of the virtual machine 3 to which a MAC address has been allocated. The identification information may also be, for example, encoded information (including the user name or password) shared by the communication control device 5 and the virtual machine 3.

The management information creation unit 514, for example, stores in the information storage area 530 the management information 531 in which the MAC address of the virtual machine 3 which has been allowed to communicate with the communication control device 5, identification information corresponding to this MAC address, and port information (also referred to hereinbelow as “first port information”) corresponding to the port of the communication control device 5 which has been allowed to communicate with the virtual machine 3 are associated with each other.

The address transmission unit 515, for example, transmits the MAC address of the virtual machine 3, which has been allocated by the MAC address allocation unit 512, to the virtual machine 3 to which this MAC address has been allocated, the transmission being performed when the management information 531 is stored by the management information creation unit 514. Further, the identification information transmission unit 516, for example, transmits the identification information on the virtual machine 3, which has been allocated by the identification information allocation unit 513, to the virtual machine 3 to which the identification information has been allocated, the transmission being performed before the management information 531 is stored by the management information creation unit 514.

The packet reception unit 517, for example, receives a packet transmitted by the virtual machine 3. The packet determination unit 518 determines whether or not to allow the communication on the basis of the MAC address, identification information, and port information when the communication is to be performed by the communication control device 5 and the virtual machine 3 that transmits a packet including the MAC address which has been stored in the information storage area 530. More specifically, for example, the packet determination unit 518 checks whether the MAC address included in the packet received from the virtual machine 3 and port information (also referred to hereinbelow as “second port information”) corresponding to the port which is to receive the packet have been stored in association with each other in the information storage area 530. Where those types of information have not been stored in association with each other, it is determined whether or not to allow the communication of the virtual machine 3 and the communication control device 5 on the basis of the identification information (also referred to hereinbelow as “second identification information”) received from the virtual machine 3 and the identification information that has been stored in association with the MAC address stored in the information storage area 530.

### First Embodiment

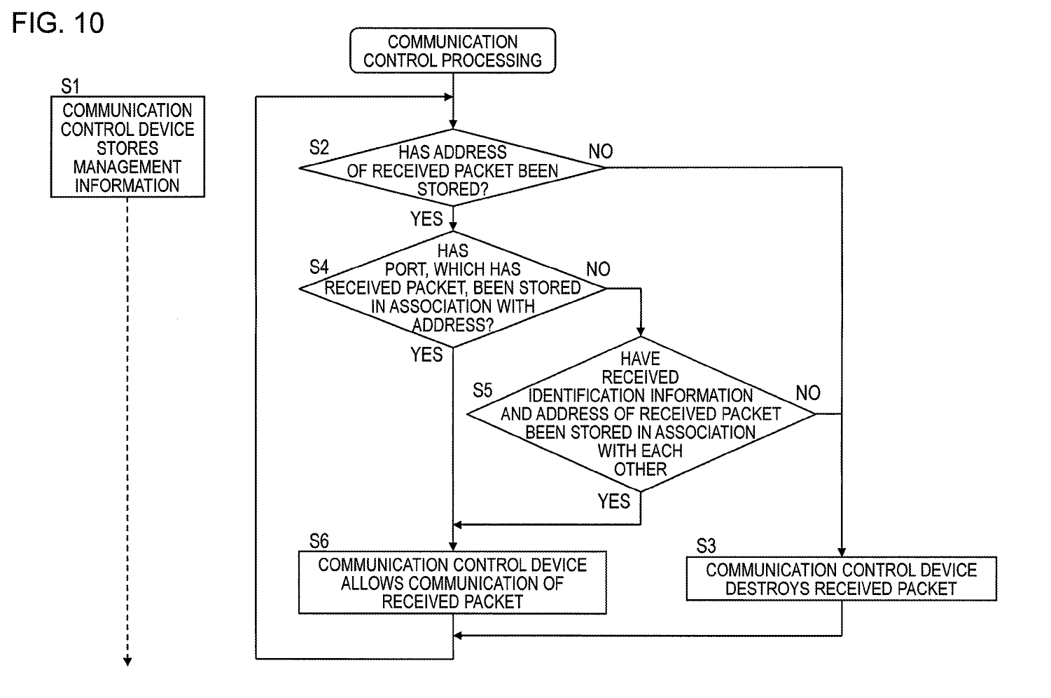

The first embodiment is explained hereinbelow. FIG. 10 is a flowchart summarizing the communication control processing of the first embodiment. More specifically, in the first embodiment, the case is explained in which the communication control device 5 allows communication with the virtual machine 3.

Initially, for example, the communication control device 5 stores the management information 531, in which the MAC address of the virtual machine 3 for which communication with the communication control device 5 has been allowed, the identification information corresponding to the MAC address, and the port information corresponding to the port of the communication control device 5 for which communication with the virtual machine 3 has been allowed have been associated with each other, in the information storage area 530 (S1). For example, when the communication control device 5 detects that the virtual machine 3 has been created, the communication control device 5 stores the management information 531 relating to the created virtual machine 3 in the information storage area 530. Further, where the information on the virtual machine 3 which is to perform the communication is clear, the communication control device 5, for example, may store the management information 531 relating to the virtual machine 3, which is to perform the communication, in the information storage area 530 before the virtual machine 3 is created. Thus, the communication control device 5 stores the MAC address of the virtual machine 3 which has been scheduled to communicate with the communication control device 5, and the port information on the port which is to communicate with the virtual machine 3 in association with each other. As a result, the virtual machine 3 for which the MAC address has been stored can perform the communication in the port which has been stored in association with the MAC address. Further, the communication control device 5 can determine (authenticate) whether or not to allow the communication of the received packet on the basis of the stored management information 531.

For example, in parallel with S1, the communication control device 5 waits till a packet is received from the virtual machine 3. When the packet is received, it is checked, by referring to the information storage area 530, whether or not the transmission source MAC address of the received packet is the MAC address which has been stored as the management information 531 in the information storage area 530 (S2). Where the transmission source MAC address of the received packet has been stored in the information storage area 530 (YES in S2), the communication control device 5, for example, checks whether or not the port information (also referred to hereinbelow as “second port information”) corresponding to the port which has received the packet has been stored in the information storage area 530 in association with the transmission source MAC address of the received packet (S4). Further, where the port that has received the packet has been stored in association with the transmission source MAC address of the received packet (YES in S4), the communication control device 5, for example, allows the communication of the received packet (S6). Thus, where the MAC address of the received packet and the port that has received the packet have been stored in the information storage area 530 in association with each other, the communication control device 5 allows the communication of this packet. Meanwhile, where the MAC address of the packet and the port that has received the packet have not been stored in association with each other, it is possible that the packet has been transmitted by a malicious user. Therefore, the communication control device 5 performs additional determination based on the identification information to determine whether or not to allow the communication.

Where the port that has received the packet has not been stored in association with the transmission source MAC address of the received packet (NO in S4), the communication control device 5, for example, checks whether or not the identification information received from the virtual machine 3 and the transmission source MAC address of the received packet have been stored in association with each other in the information storage area 530 (S5). Where the identification information received from the virtual machine 3 and the transmission source MAC address of the received packet have been stored in association with each other in the information storage area 530 (YES in S5), the communication control device 5 allows the communication of the received packet (S6). Thus, where the authentication could use the identification information, the communication of the received packet is allowed even when the MAC address of the received packet and the port which has received the packet have not been stored in association with each other in the information storage area 530. More specifically, when the MAC address of the received packet and the identification information received from the virtual machine 3 which has transmitted the packet have been stored in association with each other, the communication control device 5 determines that the virtual machine 3 has transmitted the packet to a port different from the previous port because migration has been executed. In this case, the communication control device 5 determines that this virtual machine 3 is not a virtual machine managed by a malicious user and allows the communication of the received packet.

For example, the identification information received from the virtual machine 3 may be included in all of the packets transmitted to the communication control device 5 by the virtual machines 3 communicating with the communication control device 5. In this case, the communication control device 5 can determine whether or not to allow the communication with respect to all of the packets transmitted from the virtual machines 3.

The identification information received from the virtual machine 3, for example, may be also included only in the packet that is initially transmitted to the communication control device 5 by the virtual machine 3 which performs communication with the communication control device 5. In this case, the communication control device 5, for example, updates the port information of the management information 531 relating to the received MAC address to the port information corresponding to the port which has received the packet. As a result, where packets with the same combination of the transmission source MAC address and transmission destination port are received by the communication control device 5, the communication control device can allow the communication of the received packet, without performing the authentication based on the identification information (YES in S3, YES in S4).

Meanwhile, where the transmission source MAC address of the received packet is a MAC address which has not been stored in the information storage area 530 (NO in S2), the communication control device 5 destroys the received packet (S3). Further, where the port which has received the packet and the transmission source MAC address of the packet have not been stored in association with each other and the transmission source MAC address and the identification information received from the virtual machine 3 also have not been stored in association with each other (NO in S5), the communication control device 5 also destroys the received packet (S3).

Thus, where the communication control device 5 (for example, an Ethernet fabric switch) performs the determination based only on the MAC address and the communication has been performed from the MAC address stored in the information storage area 530 to a port that has not been stored in association with this MAC address, the communication control device 5 cannot identify fraudulent communication. More specifically, where a packet has been received in a port that does not correspond to the MAC address stored in the information storage area 530, the communication control device 5 cannot distinguish between the communication in which the transmission destination port has changed following the migration and the communication performed by a malicious user. Accordingly, the communication control device 5 in the present embodiment determines whether or not communication is be allowed with respect to the received packet on the basis of the MAC address and the identification information which cannot be known to the malicious user. As a result, the communication control device 5 can distinguish between the communication in which the transmission destination port has changed following the migration and the communication performed by a malicious user.

Thus, according to the first embodiment, the communication control device 5 has the storage unit 530 that stores the management information 531 in which the MAC address of the virtual machine 3 for which communication with the communication control device 5 has been allowed, the identification information corresponding to the MAC address, and the port information corresponding to the port of the communication control device 5 for which communication has been allowed are associated with each other. Further, the communication control device 5 has the determination unit 518 which, when communication with the virtual machine 3 transmitting a packet including a MAC address is to be performed in another port of the communication control device 5 which has not been stored in the storage unit 530 in association with the MAC address, determines whether or not to allow communication of the virtual machine 3 and the communication control device 5 on the basis of the identification information received from the virtual machine 3 which is to perform the communication and the identification information corresponding to the MAC address stored in the storage unit 530. As a result, the communication control device 5 can inhibit the communication performed by the malicious user who has rewritten the MAC address. Further, the communication performed by the malicious user who has rewritten the MAC address can be inhibited even in the case in which the VLAN needs to be set when the communication control device 5 and the virtual machine 3 communicate with each other and the communication control device 5 sets the VLAN automatically. Therefore, the malicious user can be prevented from intercepting the communication relating to another user.

The communication control device 5 of the present embodiment can be used not only when a malicious user rewrites the MAC address of a physical machine (for example, the physical machine 2D in FIG. 7) to the MAC address of another virtual machine, but also when the MAC address of a virtual machine is rewritten.

### Details of the First Embodiment

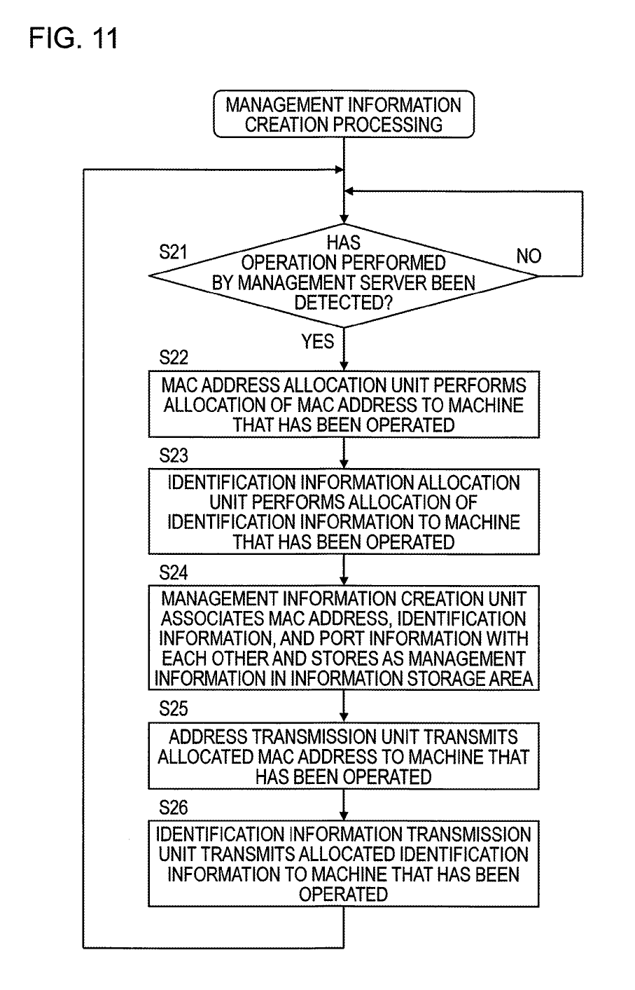

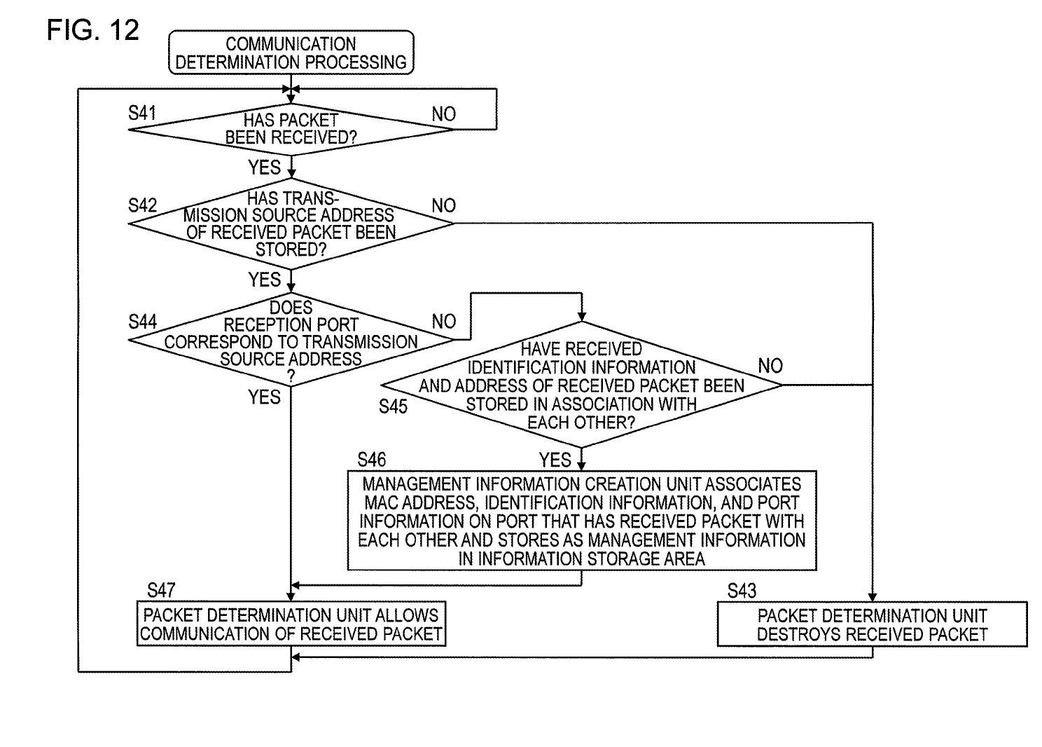

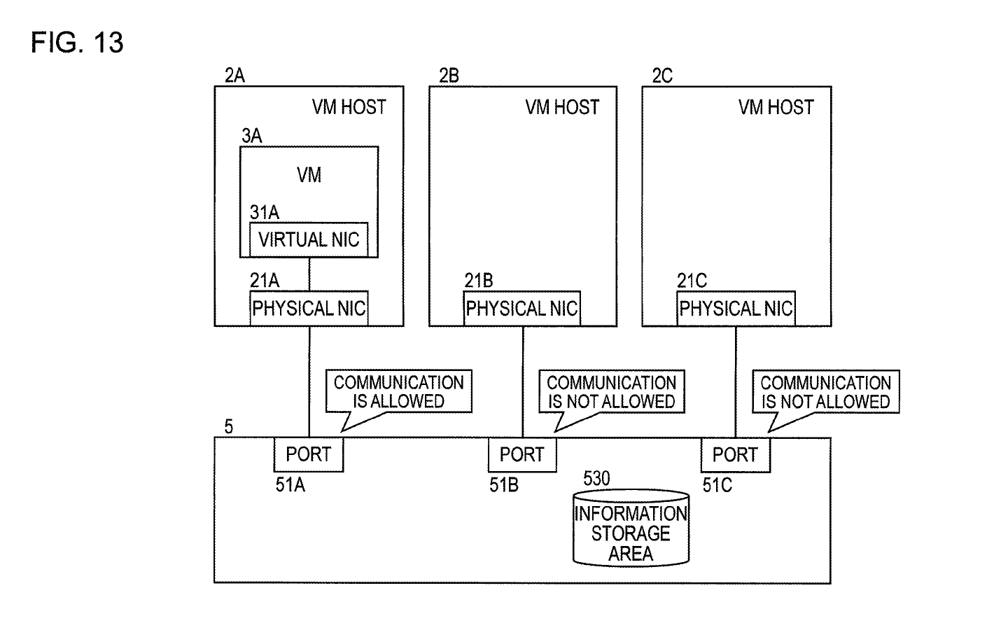

The first embodiment is described hereinbelow in greater details. FIGS. 11 and 12 are flowcharts illustrating the details of the communication control processing in the first embodiment. FIGS. 13 to 21 also illustrate the details of the communication control processing in the first embodiment. The details of the communication processing illustrated by FIGS. 11 and 12 are described with reference to FIGS. 13 to 21.

(Management Information Creation Processing)

Initially, the processing of storing management information in the communication control processing (also referred to hereinbelow as “management information creation processing”) is described. The management information creation processing corresponds to S1 in FIG. 10.

As depicted in FIG. 11, for example, the operation detection unit 511 of the communication control device 5 detects an operation performed by the management server 1 (S21). The operation performed by the management server 1, examples thereof including the creation of a virtual machine 3 to which the resources of the VM host 2 have been allocated and the indication of migration of the virtual machine created in the VM host 2, requires the update of the management information 531. The operation detection unit 511 may detect the operation performed by the management server 1, for example, when the communication control device 5 relays a notification, or the like, issued from the management server 1 to the virtual machine 3.

Then, the MAC address allocation unit 512 of the communication control device 5, for example, allocates a MAC address to the virtual machine 3 which has been operated by the management server 1 (S22). Further, the identification information allocation unit 513 of the communication control device 5, for example, allocates identification information to the virtual machine 3 which has been operated by the management server 1 (S22). Thus, where the virtual machine 3 has been created by the management server 1, a new MAC address is required for the created virtual machine 3. Further, where the migration of the virtual machine 3 is executed by the management server 1, a new MAC address to be used in the VM host 2, which is the migration destination, is required from the virtual machine 3. Therefore, when the operation of the management server is detected by the operation detection unit 511, the MAC address allocation unit 512 allocates the MAC address, and the identification information allocation unit 513 allocates the identification information to the virtual machine 3 correspondingly to the allocated MAC address. In the present embodiment, the case is explained in which the allocation of the MAC address and identification information is performed by the communication control device 5, but the allocation of the MAC address and identification information may be also performed by the management server 1.

The management information creation unit 514 of the communication control device 5 then associates the MAC address allocated by the MAC address allocation unit 512, the identification information allocated by the identification information allocation unit 513, and the port information on a port for which the communication with the created virtual machine is allowed with each other, and stores the management information 531 thus obtained in the information storage area 530 (S24). Thus, since the MAC address and port information are stored in association with each other, the communication control device 5 can allow the communication of a packet when the communication control device 5 receives, in a port stored therein, a packet including the MAC address associated with this port. Further, since the identification information is also stored in association, the communication control device 5 can perform new authentication by using the identification information when a packet including the MAC address, which has been stored in the information storage area 530, is received in a port which is not associated with this MAC address. As a result, where a malicious user has performed communication by rewriting a MAC address to become a legitimate user, the communication control device 5 can inhibit this communication.

Then, the address transmission unit 515 and the identification information transmission unit 516 of the communication control device 5, for example, transmit the MAC address allocated by the MAC address allocation unit 512 and the identification information allocated by the identification information allocation unit 513, respectively, to the created virtual machine 3 (S25, S26). Then, the operation detection unit 511, for example, waits till the next operation performed by the management server 1 is detected (S21). A specific example of the management information creation processing is described hereinbelow.

(Specific Example of Management Operation Processing)

FIGS. 13 to 17 represent an example illustrating the case in which the communication control device 5 has detected an operation performed by the management server 1 (S21). FIG. 13 represents an example in which the communication between the virtual machine 3A and the communication control device 5 is allowed. In the example represented in FIG. 13, the virtual machine 3A created in the VM host 2A communicates with the communication control device 5 in the port 51A through the virtual NIC 31A and the physical NIC 21A. The example in FIG. 13 also illustrates the state in which the VM host 2B and the VM host 2C are not allowed to communicate with the communication control device 5.

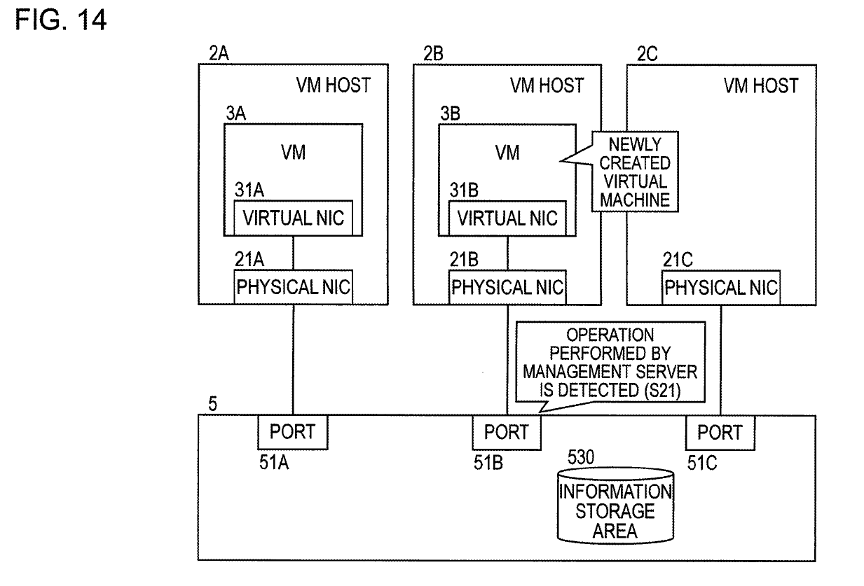

FIG. 14 represents an example in which the virtual machine 3B, which is a new virtual machine, has been created in the VM host 2 after the state depicted in FIG. 13. In the example depicted in FIG. 13, the virtual machine 3B is created, for example, on the basis of a virtual machine creation instruction transmitted from the management server 1 depicted in FIG. 1. Then, the communication control device 5, for example, detects that the virtual machine 3B has been created in the VM host 2B when an instruction to create the virtual machine 3B has been relayed from the management server 1 to the VM host 2B (S21). The communication control device 5 may detect the creation of the virtual machine 3B, for example, by receiving from the management server 1 a notification to the effect that the virtual machine 3B has been created in the VM host 2B.

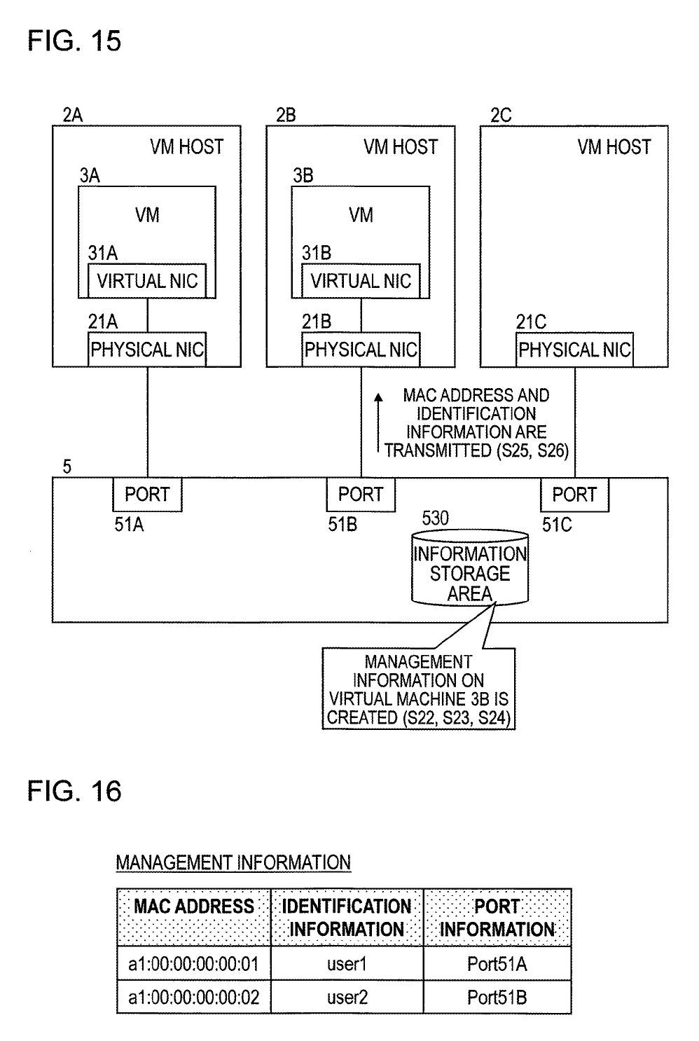

Then, as depicted in FIG. 15, the MAC address allocation unit 512 and the identification information allocation unit 513 allocate the MAC address and identification information of the virtual machine 3B in response to the detection of the operation of the management server 1 by the operation detection unit 511 (S22, S23). The management information creation unit 514 then stores the management information 531 in the information storage area 530 on the basis of the allocated MAC address and identification information (S24). The management information creation unit 514 also associates the port information on the port (port 51B in the example depicted in FIG. 15), which is to be used when the communication control device 5 is to perform communication with the virtual machine 3B, with the allocated MAC address and identification information and stores the resultant information as the management information 531. Further, the address transmission unit 515 and the identification information transmission unit 516 transmit the allocated MAC address and identification information to the created virtual machine 3B (S25, S26).

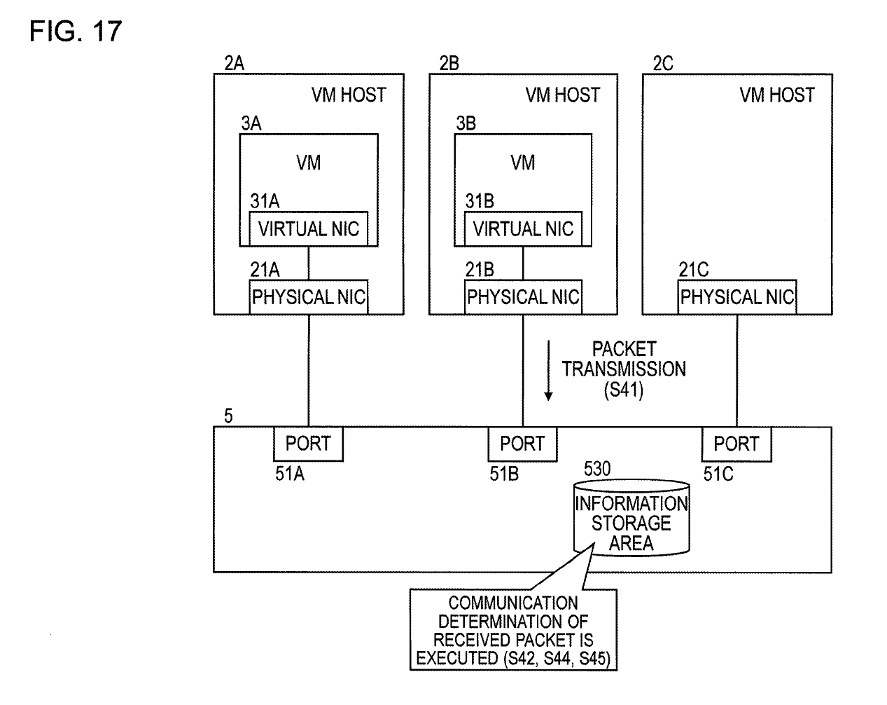

FIG. 16 represents a specific example of the management information 531 in the example depicted in FIG. 15. The management information 531 in the example depicted in FIG. 16 has the following items: “MAC ADDRESS” which is the MAC address of a virtual machine for which communication has been allowed, “IDENTIFICATION INFORMATION” which is information corresponding to the MAC address, and “PORT INFORMATION” which is information corresponding to the port of the virtual machine for which communication has been allowed. In the example depicted in FIG. 16, a1:00:00:00:00:01 which is the “MAC ADDRESS” of the virtual machine 3A, user1 which is the “IDENTIFICATION INFORMATION” corresponding to the MAC address, the “Port51A” which is the “PORT INFORMATION” on the port 51A are stored in association with each other. Further, a1:00:00:00:00:02 which is the “MAC ADDRESS” of the virtual machine 3B, user2 which is the ‘IDENTIFICATION INFORMATION” corresponding to the MAC address, the “Port51B” which is the “PORT INFORMATION” on the port 51B are stored in association with each other. Thus, as depicted in FIG. 17, the management information 531 in the present embodiment is stored by associating not only the MAC address and port information, but also the identification information that cannot be known to a malicious user. Therefore, when a packet is received, the communication control device 5 can determine whether or not to allow communication on the basis of the MAC address and identification information. As a result, even when a malicious user has performed communication by rewriting the MAC address, the communication control device 5 can inhibit this communication.

(Communication Determination Processing)

The processing of performing the determination of communication (also referred to hereinbelow as “communication determination processing”) in the communication control processing is described hereinbelow. The communication determination processing corresponds to S2 to S6 in FIG. 10.

As depicted in FIG. 12, where the packet reception unit 517 of the communication control device 5 receives a packet from the virtual machine 3 (YES in S41), the packet determination unit 518 of the communication control device 5, for example, refers to the information storage area 530 to check whether or not the transmission source MAC address of the received packet is the MAC address stored in the information storage area 530 (S42). Where the transmission source MAC address of the received packet is stored in the information storage area 530 (YES in S42), the packet determination unit 518, for example, refers to the information storage area 530 to check whether or not the port that has received the packet corresponds to the transmission source MAC address of the received packet (S44). Where the port that has received the packet corresponds to the transmission source MAC address of the received packet (YES in S44), the packet determination unit 518, for example, allows the communication of the transmission source MAC address of the received packet with the communication control device 5 (S47). Thus, where the MAC address included in the received packet and the port that has received the packet are stored in association with each other in the information storage area 530, the communication of this packet is allowed.

Where the port that has received the packet is not stored in association with the transmission source MAC address of the received packet (NO in S44), the packet determination unit 518, for example, refers to the information storage area 530 to check whether or not the identification information corresponding to the transmission source MAC address of the received packet has been stored (S45). Thus, where the MAC address included in the received packet and the port that has received the packet are not stored in association with each other in the information storage area 530, it is possible that the packet has been transmitted by a malicious user. Therefore, in this case, the packet determination unit 518 performs additional authentication by using the identification information.

Where the identification information included in the received packet is stored in the information storage area 530 in association with the transmission source MAC address of the packet (YES in S45), the management information creation unit 514, for example, updates the management information 531. More specifically, the management information creation unit 514 stores the MAC address of the received packet, the identification information corresponding to the MAC address, and the port information of the communication control device 5 that has received the packet in association with each other as the management information 531 in the information storage area 530 (S46). As a result, when a port relating to the updated management information 531 again receives a packet including the MAC address corresponding to the port, the communication control device 5 can determine whether or not to allow communication, without performing the authentication by the identification information. Therefore, the processing load in the communication control device 5 can be reduced. Further, in this case, the packet determination unit 518, for example, allows the communication of the transmission source MAC address of the received packet with the communication control device 5 (S47).

Meanwhile, where the transmission source MAC address of the received packet is a MAC address which has not been stored in the information storage area 530 (NO in S42), the communication control device 5 destroys the received packed (S43). Further, where the identification information corresponding to the transmission source MAC address of the received packet has not been stored in the information storage area 530 (NO in S45), the received packet is likewise destroyed (S43).

(Specific Example of Communication Determination Processing)

FIG. 17 illustrates the case in which a packet has been transmitted from the MAC address stored in the information storage area 530 to a port which has been stored in the information storage area 530 in association with this MAC address. As depicted in FIG. 17, where a packet transmitted from the virtual machine 3B is received in the port 51B of the communication control device 5 (S41), the packet determination unit 518 determines whether to not to allow communication with the virtual machine 3B in the port 51B (S42, S44, S45). More specifically, the management information 531 in the example depicted in FIG. 16 includes information relating to a1:00:00:00:00:02, which is the MAC address of the VM host 3B, in association with information in which the MAC address and the port information on the port 51C correspond to each other (YES in S42, YES in S44). Therefore, the packet determination unit 518 allows the communication of the packet transmitted from the virtual machine 3B (S47). Thus, the virtual machine 3B in the example depicted in FIG. 17 transmits a packet including the MAC address allocated by the communication control device 5 to the port 51B which has been stored in the information storage area 530 in association with the MAC address. Therefore, on the basis of the determination result obtained by the packet determination unit 518, the communication control device 5 determines that the virtual machine 3B is a virtual machine for which the performance of communication has been scheduled, and allows the communication.

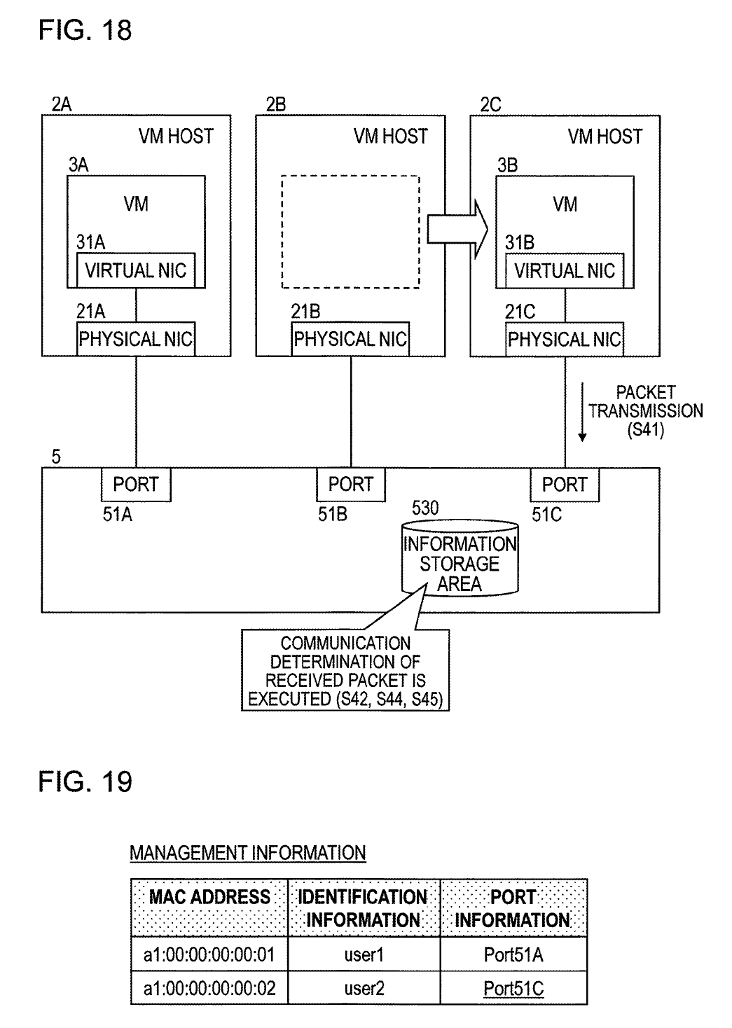

Further, FIGS. 18 to 21 illustrate the case in which a packet has been transmitted from a MAC address stored in the information storage area 530 to a port which has not been stored in the information storage area 530 in association with the MAC address. FIGS. 18 and 19 illustrate an example in which the migration of the virtual machine 3B has been executed after the state depicted in FIG. 15. As depicted in FIG. 18, where a packet from the virtual machine 3B, which has migrated from the VM host 2B to the VM host 2C, is received in the port 51C of the communication control device 5 (S41), the packet determination unit 518 determines whether or not to allow communication with the virtual machine 3B in the port 51C (S42, S44, S45). More specifically, the management information 531 in the example depicted in FIG. 18 includes information relating to a1:00:00:00:00:02, which is the MAC address of the VM host 3B, as depicted in FIG. 16, but does not include the information in which the MAC address and the port information on the port 51C are associated with each other. Therefore, in the example depicted in FIG. 18, the packet determination unit 518 refers to the information storage area 530 to determine whether or not the identification information included in the received packet includes the identification information which has been stored in association with the MAC address of the VM host 2B (YES in S42, NO in S44, and S45). Further, where the identification information included in the received packet includes the identification information which has been stored in association with the MAC address of the VM host 2B (YES in S45), the management information creation unit 514 updates the management information 531 (S46). In this case, as depicted in FIG. 19, the management information creation unit 514 updates the port information corresponding to the MAC address of the virtual machine 3B to the Port51C which is the port information corresponding to the port 51C that has received the packet. Thus, the communication control device 5 allows the communication on the basis of the result of authentication using the identification information even when the MAC address included in the received packet and the port 51C that has received the packet are not stored in association with each other in the information storage area 530. As a result, the communication control device 5 can distinguish between a packet in which the transmission destination port has been changed as a result of execution of migration and a packet transmitted by a malicious user.

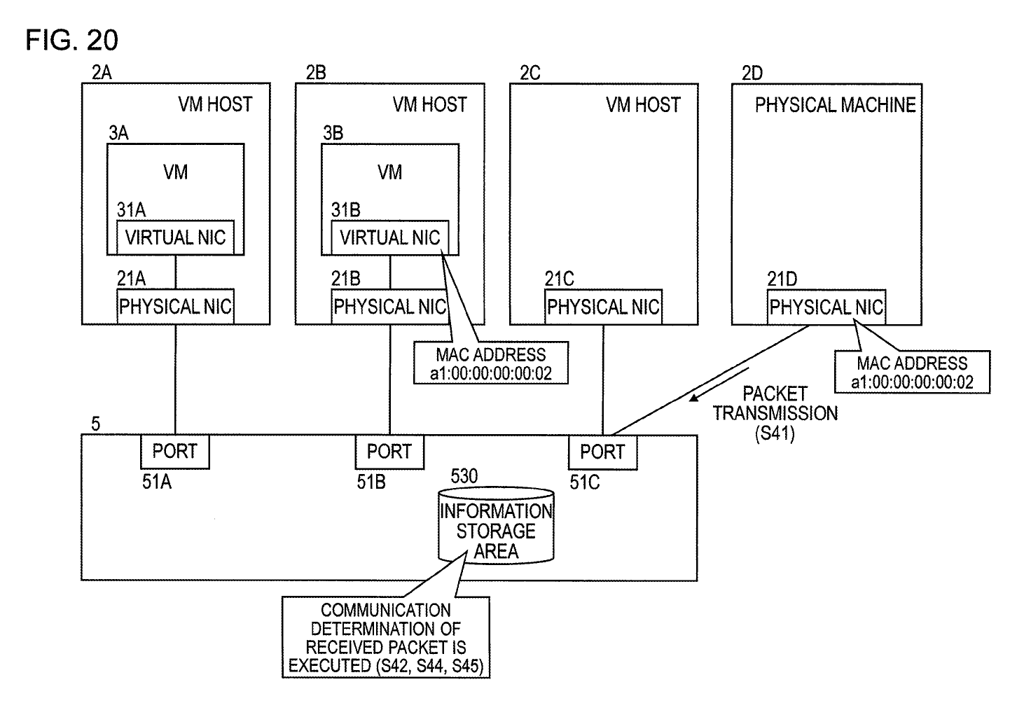

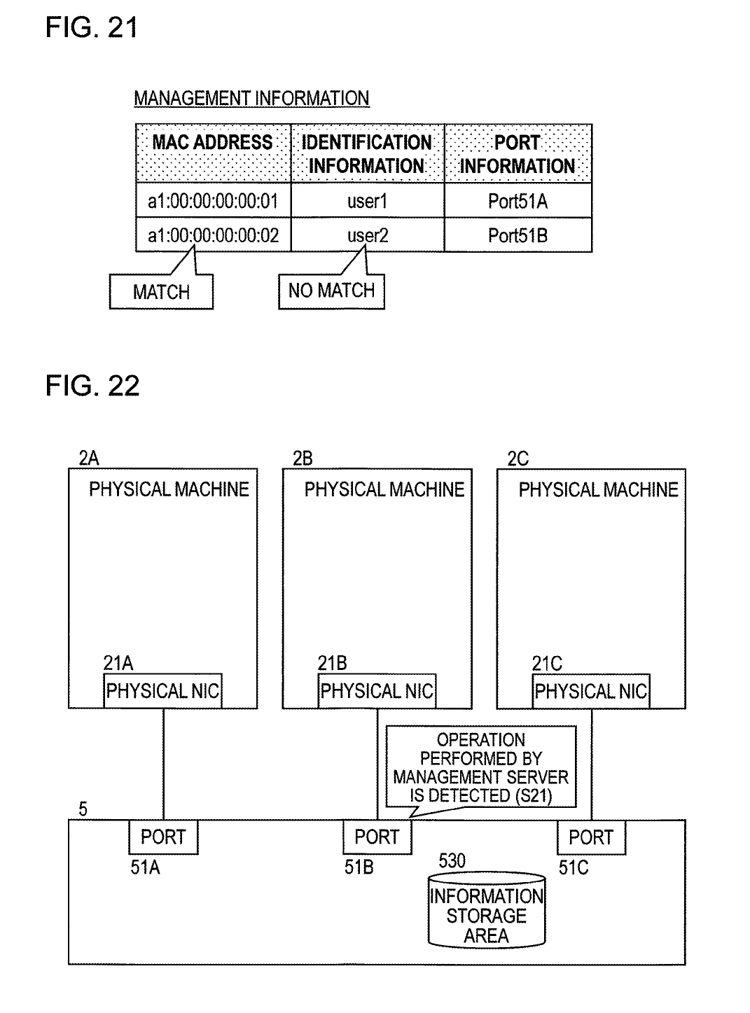

By contrast, FIGS. 20 and 21 illustrate an example in which the MAC address of a physical NIC 21D of the physical machine 2D has been rewritten to the MAC address of the virtual NIC 31B of the virtual machine 3B after the state depicted in FIG. 15. Where a packet is received in the port 51C by the physical machine 2D for which the MAC address had been rewritten (S41), as depicted in FIG. 20, the packet determination unit 518 refers to the information storage area 530 to determine whether or not to allow the communication of the physical machine 2D, for which the MAC address has been rewritten, with the port 51C (S42, S44, S45). More specifically, the management information 531 in the example depicted in FIG. 20 includes information of a1:00:00:00:00:02, which is the MAC address of the VM host 3B, in the same manner as in FIG. 17, but does not include information relating to the port information on the port 51C which corresponds to the MAC information. Therefore, the packet determination unit 518 refers to the information storage area 530 to determine whether or not the identification information corresponding to the MAC address of the VM host 2B has been received (YES in S42, NO in S44, and S45).

In this case, in the example depicted in FIG. 20, a malicious user does not know information on the identification information, which is shared by the virtual machine 3B and the communication control device 5, and therefore cannot transmit adequate identification information to the communication control device 5. As a result, information relating to the identification information on the virtual machine 3B is not stored in the information storage area 530, as depicted in FIG. 21. Therefore, the packet determination unit 518 destroys the packet transmitted from the physical machine 2D (NO in S45, and S43). As a consequence, where a malicious user transmits a packet by rewriting a MAC address, the communication control device 5 can determine that this packet has been transmitted by the malicious user.

Each port of the communication control device 5 can communicate only with one respective VM host 2. As a result, the port for which communication with a virtual machine has been allowed by the packet determination unit 518 does not receive a packet from another VM host 2.

### Second Embodiment

The second embodiment is described hereinbelow. FIGS. 22 to 24 illustrate the communication control processing in the second embodiment. More specifically, in the second embodiment, the case is explained in which the communication control device 5 allows communication with the physical machine 2. The explanation is performed by referring, as appropriate, to the flowcharts depicted in FIGS. 11 and 12.

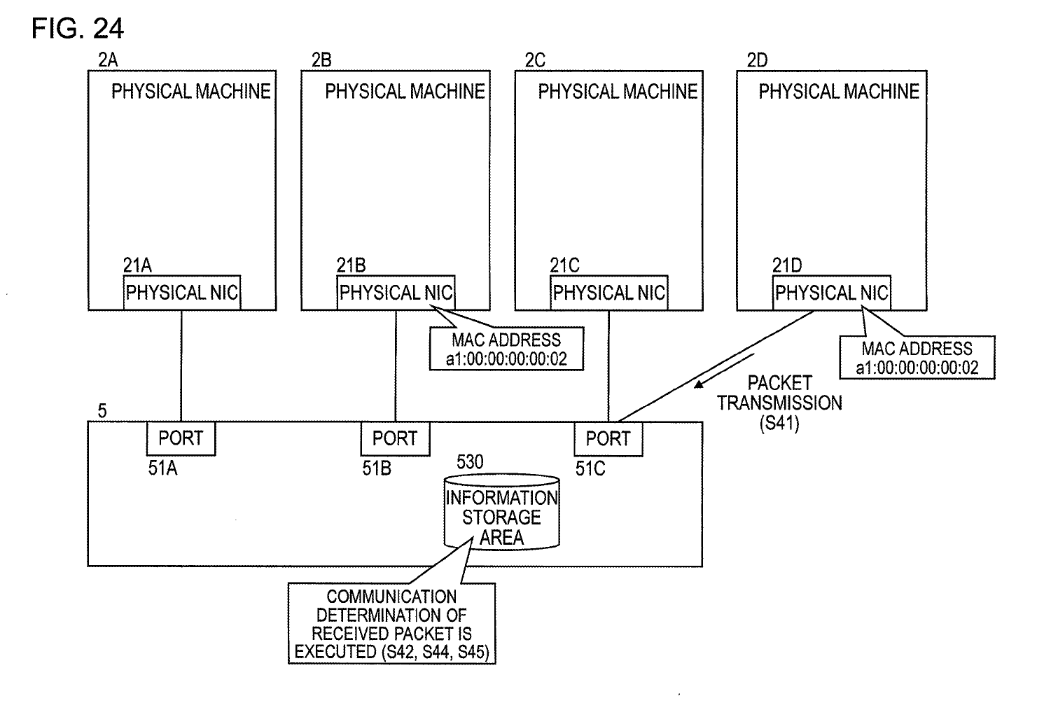

As depicted in FIG. 22, the physical machine 2B and the physical machine 2C are physical machines which are not supposed to create virtual machines. Therefore, by contrast with the first embodiment, no migration is executed between the physical machine 2B and the physical machine 2C. In this case, with respect to an information processing device performing communication, the communication control device 5 sometimes cannot determine whether this information processing device is a virtual machine that can migrate or a physical machine which cannot migrate. Therefore, as explained with reference to FIG. 4, where it is determined whether or not to allow the communication only on the basis of a MAC address, the communication control device 5 can determine that a migration has been executed even between the physical machines. More specifically, for example, where the communication control device 5 receives in the port 51C a packet transmitted from the physical machine 2D which has been rewritten to the MAC address of the physical machine 2B, as depicted in FIG. 24, it is sometimes determined that a migration has occurred between the physical machine 2B and another physical machine (in the example depicted in FIG. 24, the physical machine 2C) using the port 51C. In some cases the communication control device 5 allows the communication between the port 51C and the physical machine 2D which has been rewritten to the MAC address of the physical machine 2B. Accordingly, the communication control processing explained in the first embodiment is performed in the communication control device 5 in the same manner as in the first embodiment even when communication is allowed with a physical machine which is not supposed to create a virtual machine. As a result, interception of communication, which relates to another physical machine, by a malicious user can be prevented. A specific example of the second embodiment is explained hereinbelow.

### Specific Example of the Second Embodiment

In the example depicted in FIG. 22, the operation detection unit 511, for example, detects an operation performed by the management server 1 (S21). The operation performed by the management server 1 is, for example, the allocation of a virtual MAC address (also referred to hereinbelow as “virtual MAC address” or “virtual address”) of the physical machine 2B performed by the management server 1. The operation detection unit 511, for example, detects the allocation of the virtual MAC address to the physical machine when an instruction to allocate the virtual MAC address to the physical machine 2B is relayed from the management server 1.

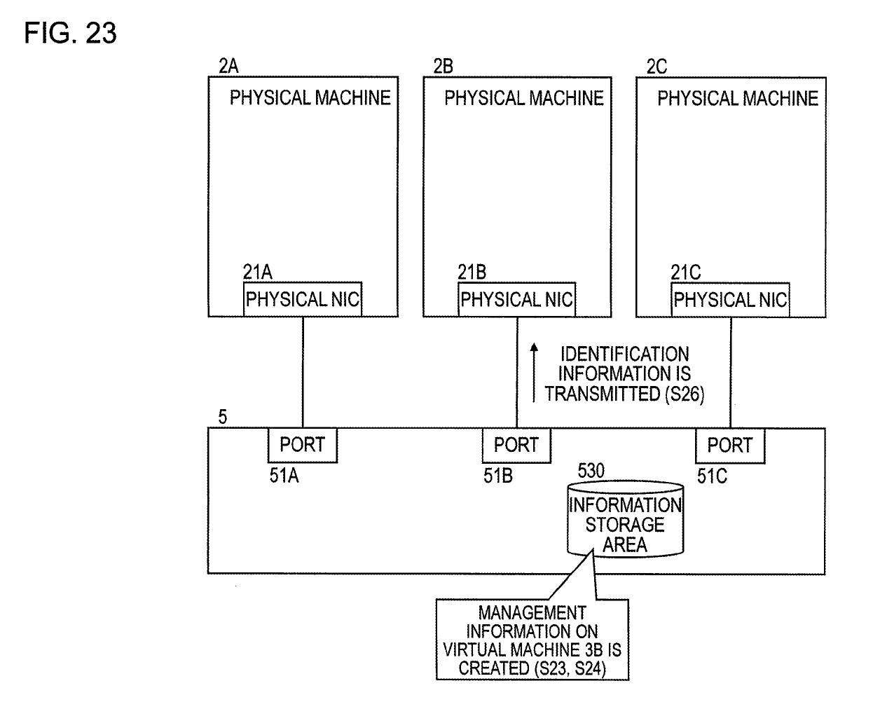

Further, as depicted in FIG. 23, in response to the detection of the operation of the management server 1 by the operation detection unit 511, the identification information allocation unit 513, for example, allocates identification information of the physical machine 2 (S23). The management information creation unit 514 then stores the management information 531 in the information storage area 530 on the basis of the virtual MAC address allocated by the management server 1 and the identification information allocated by the identification information allocation unit 513 (S24). Then, the identification information transmission unit 516, for example, transmits the allocated identification information to the physical machine 2B to which the virtual MAC address has been allocated (S26). The identification information may be information allocated by the management server 1 or the like. In this case, the identification information may be information transmitted by the management server 1 or the like.

In the case explained hereinbelow, a packet is transmitted from a physical machine in which a MAC address has been stored in the information storage area 530 to a port which has not been stored in association with this MAC address. FIG. 24 illustrates an example in which a packet is transmitted from the physical machine 2D which has been rewritten to the MAC address of the physical machine 2B to a port which has not been stored in association with the MAC address of the physical machine 2B.

Where a packet has been transmitted by the physical machine 2D, for which the MAC address has been rewritten, to the port 51C of the communication control device 5 (S41), as depicted in FIG. 24, the packet determination unit 518 refers to the information storage area 530 to determine whether or not to allow communication between the physical machine 2D, for which the MAC address has been rewritten, and the port 51C (S42, S44, S45). In this case, a malicious user does not know information on the identification information, which is shared by the physical machine 3B and the communication control device 5, and therefore cannot transmit adequate identification information to the communication control device 5. As a result, information relating to the identification information on the physical machine 2B is not stored in the information storage area 530. Therefore, the packet determination unit 518 destroys the packet transmitted from the physical machine 2D (NO in S45, and S43).

Thus, with the second embodiment, the communication control device 5 determines whether or not to allow communication on the basis of the MAC address and identification information also with respect to communication between the communication control device 5 and a physical machine which is not supposed to create a virtual machine. As a result, the communication performed by a malicious user by rewriting the MAC address can be inhibited by the communication control device 5. Further, the malicious user can be prevented from intercepting the communication relating to the physical machine of the user.

The communication control device 5 in the second embodiment can be used not only when a malicious user rewrites the MAC address of a physical machine (for example, the physical machine 2D in FIG. 24) to the MAC address of another virtual machine, but also when the MAC address of a virtual machine is rewritten.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication control device comprising:
a storage that stores management information in which a first address of a network interface of a first information processing device for which first communication with the communication control device has been allowed, first identification information corresponding to the first address, and first port information corresponding to a first port of the communication control device for which the first communication has been allowed are associated with one another; and
a determination processor that determines whether or not to allow second communication with a second information processing device on a basis of the first identification information and a second identification information, which has been received from the second information processing device performing the second communication, when the second communication is to be performed with the second information processing device transmitting a packet including the first address, in a case where the first address and a second port information corresponding to a second port of the communication control device that is to receive the packet have not been included in association with each other in the management information.

2. The communication control device according to claim 1, further comprising:
an update processor that updates the first port information included in the management information to the second port information when the determination processor allows the second communication.

3. The communication control device according to claim 2, wherein
The second port can communicate only with one information processing device; and
the determination processor does not perform a determination of whether or not to allow a communication in the second port after performing a determination that allows the second communication.

4. The communication control device according to claim 1, wherein
the determination processor performs a determination that allows the second communication when the first identification information and the second identification information match each other.

5. The communication control device according to claim 1, wherein
the first address is an address of a network interface of a virtual device created by allocation of resources of the first information processing device;
the storage stores the management information on a basis of the creation of the virtual device; and
the determination processor determines whether or not to allow the second communication with the virtual device that transmits the packet.

6. The communication control device according to claim 1, wherein
the first address is a virtual address that has been virtually allocated to the first information processing device; and
the storage stores the management information on a basis of the allocation of the virtual address to the network interface.

7. The communication control device according to claim 1, further comprising:
an allocation processor that allocates the first identification information to the first information processing device before the storage stores the management information.

8. The communication control device according to claim 7, further comprising:
a transmission processor that transmits the first identification information, which is allocated the allocation processor, to the first information processing device when the storage stores the management information.

9. The communication control device according to claim 1, wherein
the first identification information includes account information relating to the information processing device.

10. A non-transitory computer-readable storage medium storing a communication control program for causing a computer to execute a process comprising:
storing management information in which a first address of a network interface of a first information processing device for which first communication with the communication control device has been allowed, first identification information corresponding to the first address, and first port information corresponding to a first port of the communication control device for which the first communication has been allowed are associated with one another; and
determining whether or not to allow second communication with a second information processing device on a basis of the first identification information and a second identification information, which has been received from the second information processing device performing the second communication, when the second communication is to be performed with the second information processing device transmitting a packet including the first address, in a case where the first address and a second port information corresponding to a second port of the communication control device that is to receive the packet have not been included in association with each other in the management information.

11. A communication control method comprising:
storing management information in which a first address of a network interface of a first information processing device for which first communication with the communication control device has been allowed, first identification information corresponding to the first address, and first port information corresponding to a first port of the communication control device for which the first communication has been allowed are associated with one another; and
determining whether or not to allow second communication with a second information processing device on a basis of the first identification information and a second identification information, which has been received from the second information processing device performing the second communication, when the second communication is to be performed with the second information processing device transmitting a packet including the first address, in a case where the first address and a second port information corresponding to a second port of the communication control device that is to receive the packet have not been included in association with each other in the management information.
